(19) United States
(12) Patent Application Publication
(10) Pub. No.: US 2025/0238448 A1
(43) Pub. Date: Jul. 24, 2025

(54) INFORMATION PROCESSING APPARATUS, INFORMATION PROCESSING SYSTEM, AND INFORMATION PROCESSING METHOD

(71) Applicant: Masaya NEMOTO, Tokyo (JP)

(72) Inventor: Masaya NEMOTO, Tokyo (JP)

(21) Appl. No.: 19/021,228

(22) Filed: Jan. 15, 2025

(30) Foreign Application Priority Data
Jan. 22, 2024 (JP) 2024-007633

(51) Int. Cl. G06F 16/3332; G06F 3/0481; G06F 40/279

(52) U.S. Cl. CPC G06F 16/3334; G06F 3/0481; G06F 40/279

(57) ABSTRACT

An information processing apparatus includes circuitry. The circuitry receives input of task content information indicating content of a task. The circuitry determines whether the task is a task that can be supported by a tool based on the task content information. The circuitry outputs information, to a terminal device, associating the task that can be supported by a tool with candidate tools to be used to support the task.

### CROSS-REFERENCE TO RELATED APPLICATION

This patent application is based on and claims priority pursuant to 33 U.S.C. § 112 (a) to Japanese Patent Application No. 2024-007633, filed on Jan. 22, 2024, in the Japan Patent Office, the entire disclosure of which is hereby incorporated by reference herein.

### BACKGROUND

### Technical Field

The present disclosure relates to an information processing apparatus, an information processing system and an information processing method.

### Description of the Related Art

In recent years, various technologies have been known to support task improvement. One example is a technology that extracts differences between a current task process and a task process model that corresponds to the current task process and displays multiple improvement plans to reduce the extracted differences.

One method of supporting task improvement is to use tools that support task operations.

### SUMMARY

An information processing apparatus includes circuitry. The circuitry receives input of task content information indicating content of a task. The circuitry determines whether the task is a task that can be supported by a tool based on the task content information. The circuitry outputs information, to a terminal device, associating the task that can be supported by a tool with candidate tools to be used to support the task.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an example of a system configuration of an information processing system;

FIG. 2 is a diagram illustrating an example of a hardware configuration of an information processing device;

FIG. 3 is a diagram illustrating an example of a hardware configuration of a terminal device;

FIG. 4 is a diagram illustrating an example of a tool information storage unit;

FIG. 5 is a diagram illustrating a functional configuration of each device in the information processing system.

FIG. 6 is a sequence diagram illustrating an operation of the information processing system.

FIG. 7 is a diagram illustrating an example of task visualization information.

FIG. 8 is a flowchart illustrating the processing of a first analysis unit.

FIG. 9 is a flowchart illustrating the processing of a second analysis unit.

FIG. 10 is a first diagram illustrating an example of a display on the terminal device.

FIG. 11 is a second diagram illustrating an example of a display on the terminal device.

FIG. 12 is a third diagram illustrating an example of a display on the terminal device.

FIG. 13 is a fourth diagram illustrating an example of a display on the terminal device.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Referring to the drawings, several embodiments of the present invention are described.

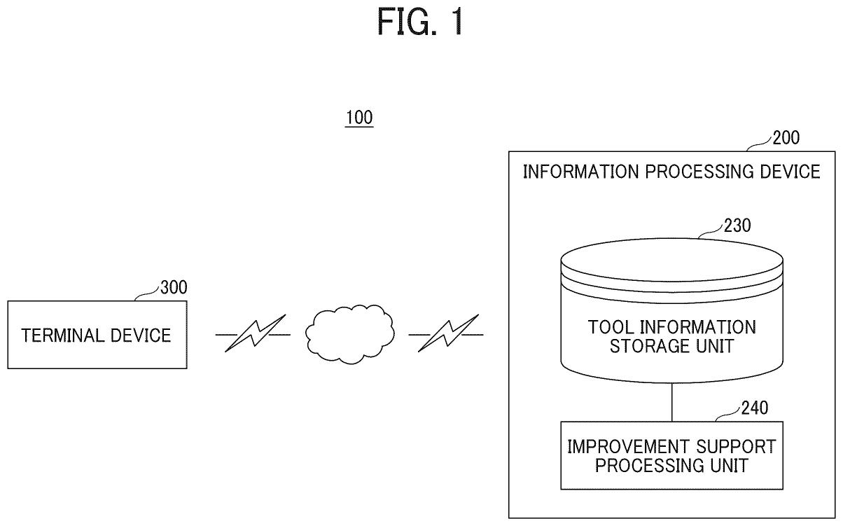

The following describes an embodiment with reference to the drawings. FIG. 1 shows an example of the configuration of an information processing system.

The information processing system 100 of this embodiment includes an information processing device 200 and a terminal device 300, and the information processing device 200 and the terminal device 300 are connected via a network or the like.

In the information processing system 100 of this embodiment, when the information processing device 200 acquires information indicating the content of a task from the terminal device 300, the information processing device 200 analyzes the information indicating the content of the task and outputs candidates for software for automating the task to the terminal device 300. In the following description, the information indicating the content of the task is referred to as task content information.

The task content information may be task visualization information in which a task is visualized using an existing task visualization method or may be any text data input by a user of the terminal device 300. In other words, the task content information in this embodiment may be either task visualization information or text data.

The information processing device 200 of this embodiment includes a tool information storage unit 230 and an improvement support processing unit 240.

The tool information storage unit 230 stores information about existing software for supporting business operations. In other words, the tool information storage unit 230 stores information about existing software used to support task operations. In the following description, existing software used to support task operations is referred to as a tool, and information about existing software used to support task operations is referred to as tool information. Existing software for supporting task operations is, specifically, existing software for automating task operations. Details of tool information will be provided later.

When the improvement support processing unit 240 acquires the task content information, it extracts words that will serve as search keys for searching for tool information from the acquired task content information. The improvement support processing unit 240 then searches the tool information storage unit 230 using the extracted search keys and identifies candidate tools that are suitable for automating the task.

The tool information storage unit 230 then causes the terminal device 300 to display the task content information in association with candidate tools suitable for automating the task.

Therefore, according to this embodiment, a user of the terminal device 300 can identify candidate tools for automating task operations simply by inputting task content information, and no specialized knowledge, experience, etc. is required to automate task operations.

In this way, according to this embodiment, it is possible to easily grasp the overview of task automation and support task improvement. Furthermore, according to this embodiment, it is possible to easily grasp a task that can be supported by tools and candidate tools to be used for support.

In the example of FIG. 1, the information processing device 200 is a single information processing device, but this is not limited to this. The information processing device 200 may be realized by multiple information processing devices. In addition, in the example of FIG. 1, the tool information storage unit 230 is included in the information processing device 200, but this is not limited to this. The tool information storage unit 230 may be provided in an external device capable of communicating with the information processing device 200. In addition, the improvement support processing unit 240 may be realized by multiple information processing devices.

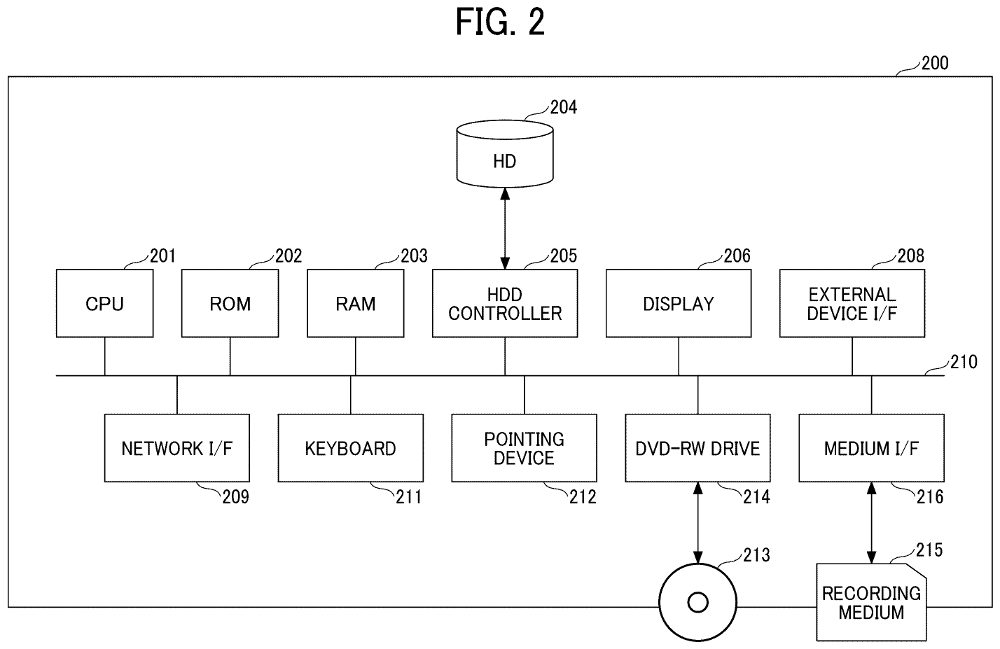

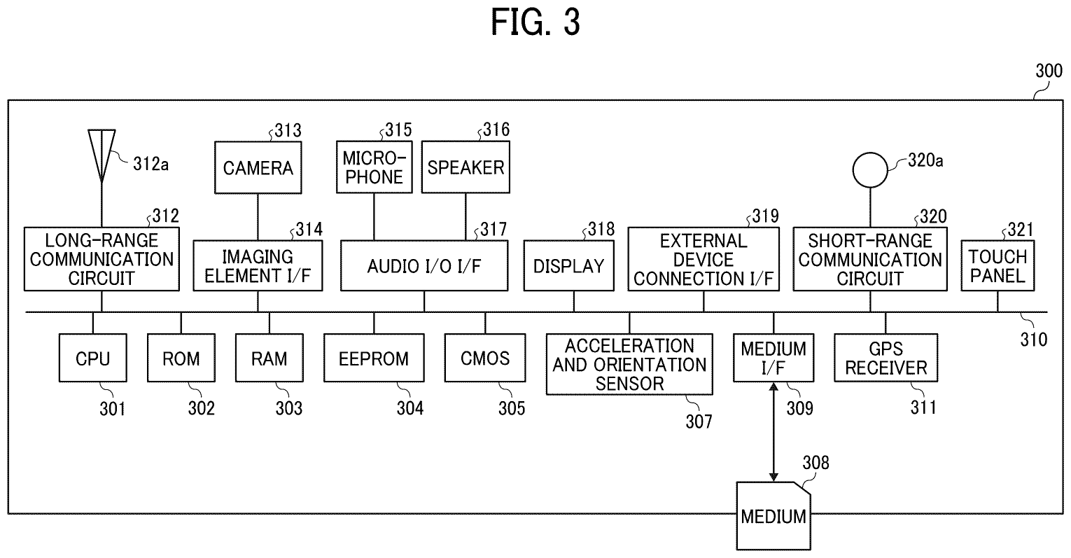

Next, the hardware configurations of the information processing device 200 and the terminal device 300 of this embodiment will be described with reference to FIG. 2 and FIG. 3.

The components of the information processing device 200 and the terminal device 300 may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the functionality disclosed below. Processors are considered processing circuitry or circuitry as they include transistors and other circuitry therein. In the disclosure, the circuitry, units, devices or means are hardware that carry out or are programmed to perform the functionality. The hardware may be any hardware disclosed herein which is programmed or configured to carry out the functionality.

FIG. 2 is a diagram illustrating an example of a hardware configuration of the information processing device 200 according to the present embodiment. As illustrated in FIG. 2, the information processing device 200 each are implemented by a computer and each include a central processing unit (CPU) 201, a read-only memory (ROM) 202, a random access memory (RAM) 203, a hard disk (HD) 204, a hard disk drive (HDD) controller 203, a display 206, an external device interface (I/F) 208, a network I/F 209, a bus line 210, a keyboard 211, a pointing device 212, an optical drive 214, and a medium I/F 216.

The CPU 201 includes circuitry that controls all the operations of the information processing device 200. The ROM 202 stores programs such as an initial program loader (IPL) to boot the CPU 201. The RAM 203 is used as a work area for the CPU 201. The HD 204 stores various kinds of data such as a program. The HDD controller 203 controls reading or writing of various kinds of data from or to the HD 204 under control of the CPU 201. The display 206 displays various kinds of information such as a cursor, a menu, a window, characters, or an image. The external device I/F 208 is an interface for connecting various external devices. Examples of the external devices in this case include, but are not limited to, a USB memory and a printer. The network I/F 209 is an interface for performing data communication via a network. The bus line 210 is, for example, an address bus or a data bus for electrically connecting the components such as the CPU 201 illustrated in FIG. 2 to one another.

The keyboard 211 is a kind of an input device including a plurality of keys used for inputting characters, numerical values, various instructions, or the like. The pointing device 212 is a kind of an input device used to select or execute various instructions, select a target for processing, or move a cursor. The optical drive 214 controls the reading or writing of various kinds of data from or to an optical recording medium 213 that is an example of a removable recording medium. The optical recording medium 213 may be a compact disc (CD), a digital versatile disc (DVD), a BLU-RAY disc, or the like. The medium I/F 216 controls reading or writing (storing) of data from or to a recording medium 213 such as a flash memory.

FIG. 3 is a diagram illustrating a hardware configuration of the terminal device 300. As illustrated in FIG. 3, the terminal device 300 includes a CPU 301, a ROM 302, a RAM 303, an EEPROM 304, a CMOS sensor 305, an acceleration and orientation sensor 306, a medium I/F 308, and a global positioning system (GPS) receiver 311.

The CPU 301 includes circuitry that controls all the operations of the terminal device 300. The ROM 302 stores programs such as an IPL to boot the CPU 301. The RAM 303 is used as a work area for the CPU 301. The EEPROM 304 reads or writes various data such as a control program for the terminal device 300 under control of the CPU 301. The CMOS sensor 305 captures an object (mainly, a user operating the terminal device 300) under control of the CPU 301 to obtain image data. The acceleration and orientation sensor 307 includes various sensors such as an electromagnetic compass for detecting geomagnetism, a gyrocompass, or an acceleration sensor. The medium I/F 309 controls reading or writing of data with respect to a recording medium 308 such as a flash memory. The GPS receiver 311 receives a GPS signal from a GPS satellite.

The terminal device 300 further includes a long-range communication circuit 312, an antenna 312a for the long-range communication circuit 312, a camera 313, an imaging element I/F 314, a microphone 315, a speaker 316, an audio input/output interface 317, a display 318, an external device connection I/F 318, a short-range communication circuit 320, an antenna 320a for the short-range communication circuit 312, and a touch panel 321.

The long-range communication circuit 312 is a circuit that communicates with other device through the communication network. The camera 313 is an example of a built-in imaging device capable of capturing a subject under control of the CPU 201 to obtain image data. The imaging element I/F 314 is a circuit that controls driving of the camera 313. The microphone 315 is an example of a built-in audio collecting device capable of inputting audio. The audio input/output interface 317 is a circuit for controlling input and output of audio signals between the microphone 315 and the speaker 316 under control of the CPU 301. The display 318 is an example of a display unit, such as a liquid crystal or organic electroluminescence (EL) display that displays an image of a subject, an operation icon, or the like. The external device connection I/F 319 is an interface circuit that connects terminal device 300 to various external devices. The short-range communication circuit 320 is a communication circuit that communicates in compliance with the NFC, the Bluetooth and the like. The touch panel 321 is an example of an input device to operate terminal device 300 by touching a screen of the display 318.

The terminal device 300 further includes a bus line 310. Examples of the bus line 310 include an address bus and a data bus, which electrically connects the elements such as the CPU 301.

It should be noted that a recording medium such as a CD-ROM or a hard disk storing any one of the above-described programs may be distributed domestically or overseas as a program product.

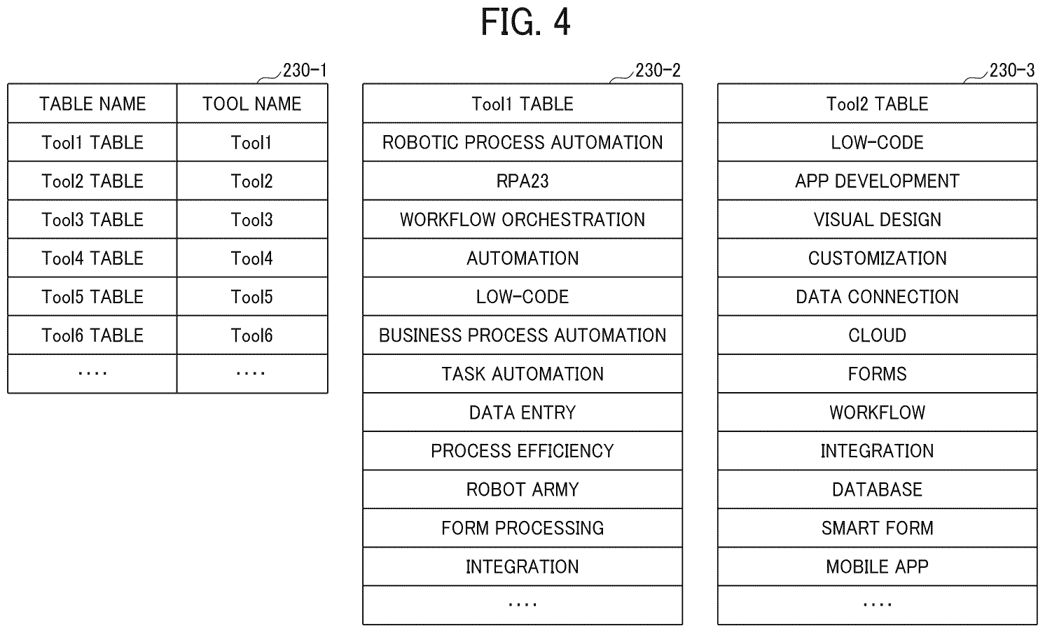

Next, the tool information storage unit 230 of this embodiment will be described with reference to FIG. 4.

FIG. 4 is a diagram illustrating an example of a tool information storage unit. The tool information stored in the tool information storage unit 230 of this embodiment includes a table in which tool names are associated with keywords associated with the tools. In this embodiment, it is assumed that the tool information is stored in the tool information storage unit 230 in advance.

Specifically, the tool information storage unit 230 includes tables 230-1, 230-2, 230-3, and so on.

Table 230-1 is information that associates table names with tool names. In table 230-1, it can be seen that the tool name “Tool1” is associated with the table name “Tool1 Table,” and that the tool name “Tool2” is associated with the table name “Tool2 Table.”

Table 230-2 is information in which a tool name “Tool1” is associated with a keyword, and table 230-3 is information in which a tool name “Tool2” is associated with a keyword.

In table 230-2, keywords such as “Robotic Process Automation” and “RPA23” are associated with the tool name “Tool1.” In addition, in table 230-3, keywords such as “low-code” and “app development” are associated with the tool name “Tool2.”

The tool indicated by the tool name “Tool1” may be, for example, software that creates an automated workflow between applications and services and performs file synchronization, notification reception, data collection, etc. The tool indicated by the tool name “Tool2” may be, for example, software that creates an application that systemizes and streamlines task operations without using code.

Furthermore, the tool information storage unit 230 may include various kinds of tool information other than the tool information of the above-mentioned tools.

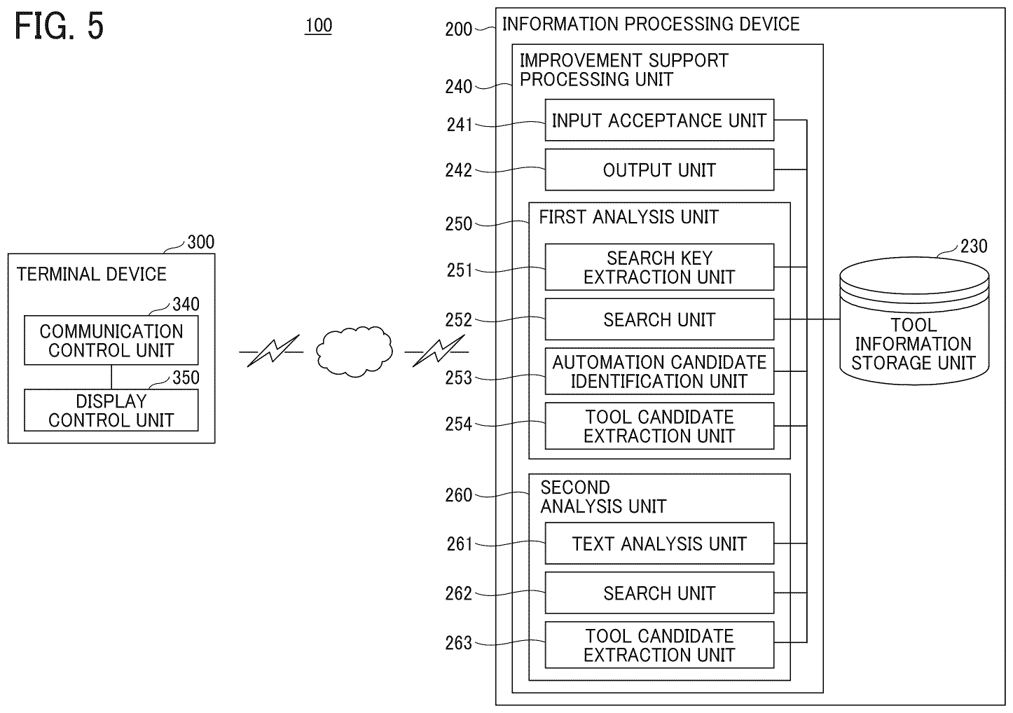

Next, the functions of each device included in the information processing system 100 of this embodiment will be described with reference to FIG. 5. FIG. 5 is a diagram illustrating the functional configuration of each device in the information processing system.

First, a description will be given of the functions of the information processing device 200. The information processing device 200 of this embodiment includes a tool information storage unit 230 and an improvement support processing unit 240.

The improvement support processing unit 240 includes an input acceptance unit 241, an output unit 242, a first analysis unit 250, and a second analysis unit 260.

The input acceptance unit 241 accepts input of various types of information into the information processing device 200. Specifically, the input acceptance unit 241 accepts input of task content information. The input acceptance unit 241 also accepts input corresponding to operations on a screen displayed on the terminal device 300.

The output unit 242 outputs various information from the information processing device 200. Specifically, the output unit 242 outputs analysis results of the first analysis unit 250, analysis results of the second analysis unit 260, etc. to the terminal device 300.

When task visualization information is input as task content information, the first analysis unit 250 analyzes the task visualization information and matches processes included in the task that can be subject to automation with candidate tools to be used to automate these processes. Task visualization information is information that visualizes the processes (steps) and loads included in a task using existing methods for visualizing tasks. Details of the task visualization information will be described later.

The first analysis unit 250 includes a search key extraction unit 251, a search unit 252, an automation candidate identification unit 253, and a tool candidate extraction unit 254.

The search key extraction unit 251 extracts a search key from the task visualization information accepted as input by the input acceptance unit 241. Specifically, the search key extraction unit 251 may extract, as the search key, the name of a task process included in the task visualization information.

The search unit 252 searches the tool information storage unit 230 for each process name extracted by the search key extraction unit 251.

The automation candidate identification unit 253 identifies processes whose names and corresponding keywords have been extracted by the search by the search unit 252 as candidates for processes that can be automated.

In other words, the automation candidate identification unit 253 is an example of an identification unit that identifies processes that can be supported by a tool from among the task processes indicated by the task visualization information.

The tool candidate extraction unit 254 extracts tools associated with the keywords obtained by the search in the tool information storage unit 230 as candidates for tools that will realize the automation of this process.

When text data is input as task content information, the second analysis unit 260 searches the tool information storage unit 230 for words contained in the text data and determines tools corresponding to keywords in the search results as candidates for tools that will realize automation of the task indicated by the text data.

The second analysis unit 260 includes a text analysis unit 261, a search unit 262, and a tool candidate extraction unit 263.

The text analysis unit 261 performs morphological analysis, etc. on the text data accepted by the input acceptance unit 241, and extracts words that will serve as search keys from the text data.

The search unit 262 searches the tool information storage unit 230 for each word obtained by the analysis of the text analysis unit 261.

The tool candidate extraction unit 263 extracts tools associated with keywords obtained as search results by the search unit 262 as candidates for tools that will realize the automation of the tasks indicated by the text data.

In other words, the tool candidate extraction unit 263 identifies a task indicated by text data for which keywords have been obtained as a search result by the search unit 262 as a task for which support can be provided by a tool, and extracts tool candidates associated with the keywords. Therefore, the tool candidate extraction unit 263 is an example of an identification unit that identifies a task for which support can be provided by a tool.

Next, the functional configuration of the terminal device 300 will be described. The terminal device 300 of this embodiment includes a communication control unit 340 and a display control unit 350. The communication control unit 340 controls the transmission and reception of information between the terminal device 300 and the information processing device 200. The display control unit 350 controls various displays on the display 318 of the terminal device 300.

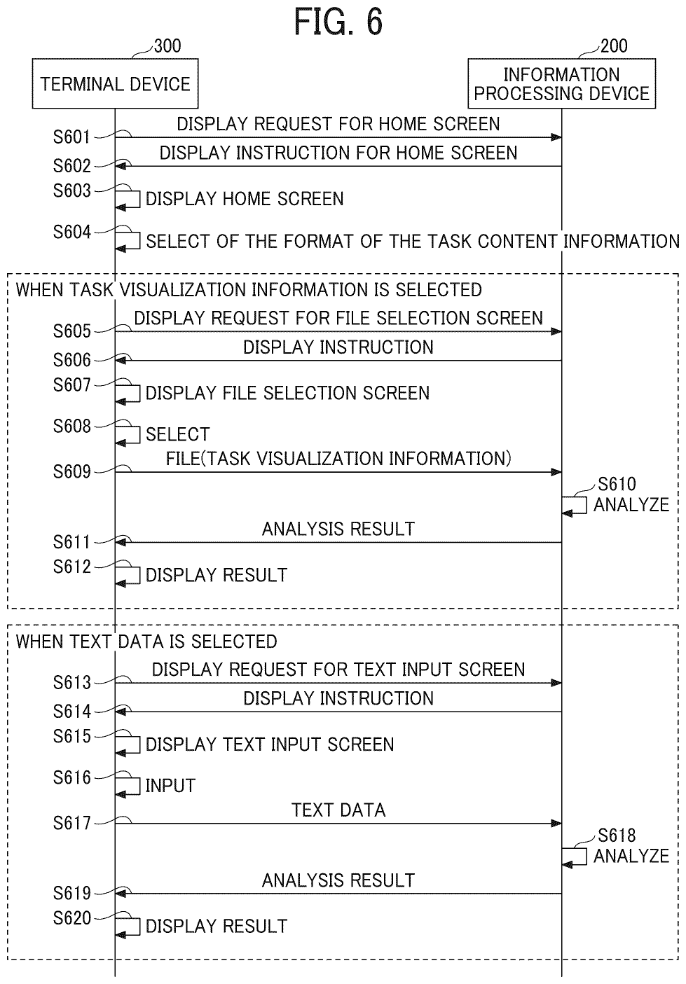

Next, the operation of the information processing system 100 of this embodiment will be described with reference to FIG. 6. FIG. 6 is a sequence diagram illustrating the operation of the information processing system.

In the information processing system 100 of this embodiment, the terminal device 300 transmits a display request for a home screen to the information processing device 200 via the communication control unit 340 in response to an operation by a user (step S601).

When the information processing device 200 receives the request to display the home screen, it transmits an instruction to display the home screen to the terminal device 300 (step S602). The terminal device 300 receives this display instruction and causes the display control unit 350 to display the home screen on the display 318 (step S603).

The home screen of this embodiment is an example of a screen that is displayed when starting to use a service provided by the information processing device 200. In addition, in this embodiment, the home screen allows a selection to be made as to whether the task content information to be input to the information processing device 200 is to be task visualization information or text data. In other words, the home screen of this embodiment can be said to be a screen for selecting the format of the task content information to be transmitted to the information processing device 200.

First, an operation when task visualization information is selected as the format of task content information in step S604 will be described.

The terminal device 300 accepts the selection of the format of the task content information on the home screen (step S604).

The processes from step S605 to step S612 in FIG. 6 show the operation when task visualization information is selected as the format of task content information in step S604. The processes from step S613 to step S620 in FIG. 6 show the operation when text data is selected as the format of task content information in step S604.

If task visualization information is selected in step S604, the terminal device 300 transmits to the information processing device 200 a display request for a file selection screen for selecting task visualization information to be input (step S605). The information processing device 200 accepts this display request and transmits to the terminal device 300 an instruction to display the file selection screen (step S606).

The terminal device 300 accepts this display instruction and displays a file selection screen for the task visualization information (step S607). The file selection screen displayed here may display a list of task visualization information that the terminal device 300 has acquired.

When the terminal device 300 accepts an operation to select the task visualization information on the file selection screen (step S608), the terminal device 300 transmits the selected task visualization information to the information processing device 200 (step S609).

When the information processing device 200 receives the task visualization information, the first analysis unit 250 analyzes the task visualization information (step S610), and the output unit 242 transmits information indicating the analysis result to the terminal device 300 (step S611). The terminal device 300 causes the information indicating the analysis result to be displayed on the information processing device 200 (step S612). The processing of the first analysis unit 250 will be described in detail later.

In this embodiment, information indicating the analysis results by the first analysis unit 250 may be stored in the information processing device 200.

Next, an operation when text data is selected as the format of the task content information in step S604 will be described.

If text data is selected in step S604, the terminal device 300 transmits a display request to the information processing device 200 for a screen including an input field for the text data (text input screen) (step S613). The information processing device 200 accepts this display request and transmits an instruction to the terminal device 300 to display the text input screen (step S614).

The terminal device 300 accepts this display instruction and displays the text input screen (step S615).

When the terminal device 300 accepts an operation to input text data on the text input screen (step S616), the terminal device 300 transmits the input text data to the information processing device 200 (step S617).

When the information processing device 200 receives the text data, the second analysis unit 260 analyzes the text data (step S618), and the output unit 242 transmits information indicating the analysis result to the terminal device 300 (step S619). The terminal device 300 causes the information processing device 200 to display the information indicating the analysis result (step S620). The processing by the second analysis unit 260 will be described in detail later.

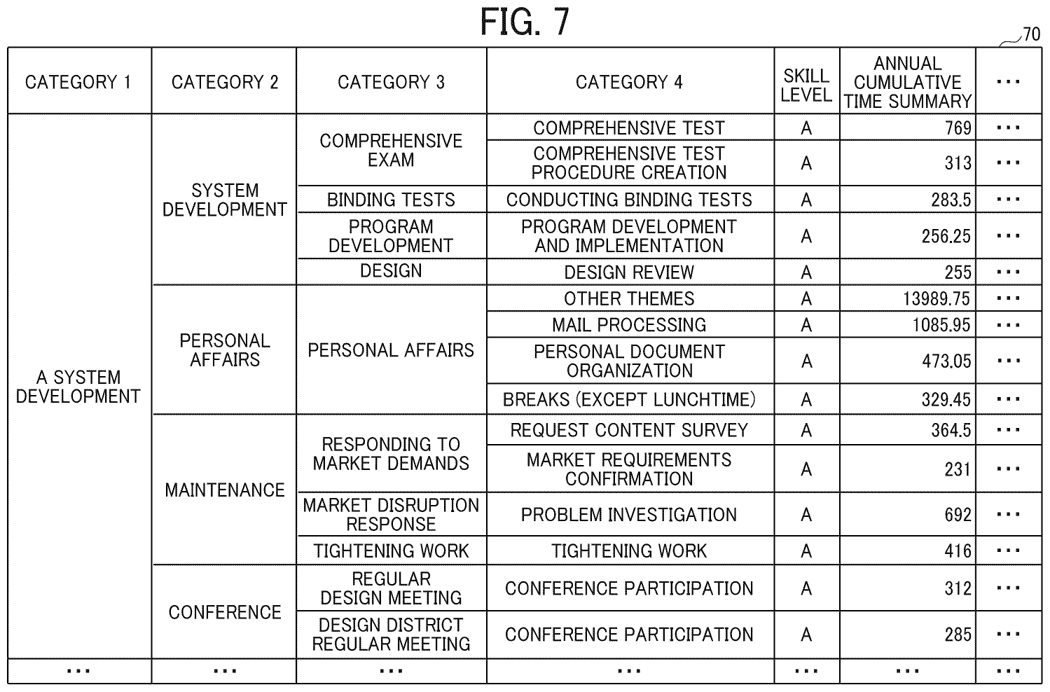

Here, we will explain the task visualization information of this embodiment. FIG. 7 is a diagram showing an example of task visualization information.

The task visualization information in this embodiment is information that classifies the processes included in a task by task content, and tabulates a load, a cost, a person in charge, etc. for each process.

The task visualization information 70 shown in FIG. 7 is an example of task visualization information and is task visualization information that visualizes the load for each process included in a development task of an “A system.”

In the task visualization information 70, the values of the items “Category 1,” “Category 2,” “Category 3,” and “Category 4” each indicate the process when the task content is classified. Category 1 indicates the process when the task content is classified in the least detailed manner, and Category 4 indicates the process when the task content is classified in the most detailed manner.

In the task visualization information 70, it can be seen that the process “A System Development” is classified into processes “System Development”, “Personal Affairs”, “Maintenance”, “Conference”, etc., and the process “System Development” is further classified into processes “Comprehensive Exam”, “Binding Tests”, “Program Development”, etc.

The value of the item “skill level” indicates the level of difficulty for each process associated with the item “category 4.” In this embodiment, a process for which the value of the item “skill level” is “A” indicates the most difficult process that only a limited number of people can perform, while a process for which the value of the item “skill level” is “D” indicates the easiest process that anyone can perform.

The value of the item “Annual cumulative time summary” indicates the cumulative total task time for one year for each process associated with the item “Category 4.” In other words, the value of the item “Annual cumulative time summary” indicates the magnitude of the load for each process associated with the item “Category 4.”

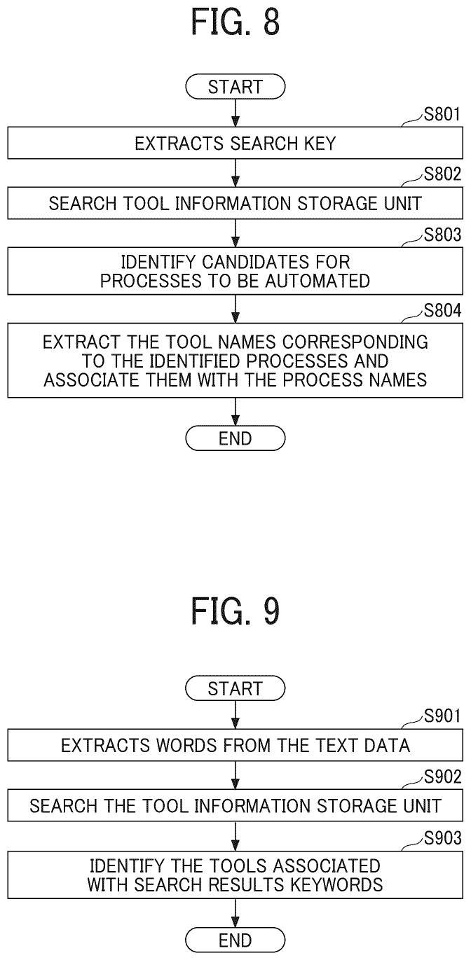

Next, the processing of the first analysis unit 250 and the processing of the second analysis unit 260 of the information processing device 200 will be described with reference to FIGS. 8 and 9. FIG. 8 is a flowchart explaining the processing of the first analysis unit. FIG. 8 shows details of the processing of the first analysis unit 250 in step S610 of FIG. 6.

In the information processing device 200 of this embodiment, when the input acceptance unit 241 receives input of task visualization information, the search key extraction unit 251 of the first analysis unit 250 extracts a search key from the task visualization information (step S801). Specifically, the search key extraction unit 251 extracts, as a search key, the name of the task process associated with the item “Category 4” in the task visualization information.

Next, the first analysis unit 250 of the information processing device 200 causes the search unit 252 to search the tool information storage unit 230 for each search key extracted by the search key extraction unit 251 (step S802).

Next, based on the search results, the first analysis unit 250 uses the automation candidate identification unit 253 to identify candidates for processes to be automated (step S803). In other words, the automation candidate identification unit 253 identifies processes that can be supported by tools based on the task content information.

Specifically, the automation candidate identification unit 253 searches the tool information storage unit 230 for the name of the process that is the search key and identifies the process for which the keyword stored in the tool information storage unit 230 is obtained as the search result as a candidate process to be automated.

In addition, the keywords obtained as the search results by the search unit 252 may be only keywords that completely match the name of the task process that is the search key or may include keywords that partially match the name of the task process that is the search key.

Next, the first analysis unit 250, using the tool candidate extraction unit 254, identifies candidate tools for realizing the automation of the process identified by the automation candidate identification unit 253, and associates the names of the identified tools with the names of the processes to obtain the analysis results (step S804).

Specifically, the tool candidate extraction unit 254 identifies candidate tools for realizing the automation of the identified process by using the keywords extracted by a search using the name of the process identified in step S803 as a search key and the tools associated in the tool information storage unit 230.

The first analysis unit 250 of this embodiment may perform the processes of steps S802 to S805 for each of the search keys extracted in step S801 and pass the results to the output unit 242 as information indicating the analysis results.

Next, the processing of the second analysis unit 260 of the information processing device 200 will be described with reference to FIG. 9. FIG. 9 is a flowchart explaining the processing of the second analysis unit. FIG. 9 shows details of the processing of the second analysis unit 260 in step S618 of FIG. 6.

In the information processing device 200 of this embodiment, when the input receiving unit 241 receives input of text data, the text analysis unit 261 of the second analysis unit 260 extracts words from the text data (step S901). Specifically, the text analysis unit 261 may extract words by performing morphological analysis or the like on the input text data.

Next, the second analysis unit 260 of the information processing device 200 causes the search unit 262 to search the tool information storage unit 230 for each word extracted by the text analysis unit 261 (step S902).

Next, the second analysis unit 260 causes the tool candidate extraction unit 263 to identify tool candidates that realize the automation of the task content indicated by the text data and sets these as analysis results (step S903).

Specifically, the tool candidate extraction unit 263 may determine the tool with the most keywords extracted in the word-by-word search by the search unit 262 as a candidate for a tool that can automate the task content indicated by the text data.

In addition, the tool candidate extraction unit 263 may identify multiple tools in order of the number of keywords extracted in the word-by-word search by the search unit 262 and set the identified multiple tools as candidates for tools that will realize the automation of the task content indicated by the text data.

Furthermore, the tool candidate extraction unit 263 may extract a combination of tools that realize the automation of the task content indicated by the text data, based on the keywords extracted in the word-by-word search by the search unit 262. Specifically, for example, if the task content indicated by the input text data is “automation of the task of copying the contents of a progress report file and displaying the tabulated results,” a combination of tools that realize the automation of the task content indicated by the text data may be extracted, which is a tool associated with a keyword related to the word “copy” and a tool associated with the word “tabulated results.”

In this case, the terminal device 300 may display words and tool names in association with each other. Specifically, for example, assume that the tool name of the tool associated with the word “Copy” is “Tool3” and the tool name of the tool associated with the word “Tally results” is “Tool4”. In this case, the terminal device 300 displays the words and tool names in association with each other, such as “Copy”: Tool3 and “Tally results”: Tool4.

In this way, by displaying words in association with tool names, the user of the terminal device 300 can recognize the associated tool name for each word extracted from the text data and understand the function of each tool.

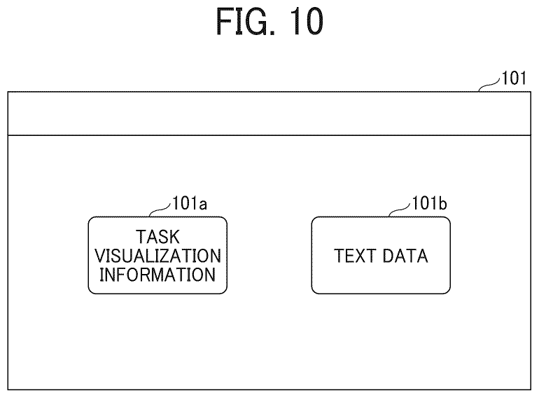

Next, display examples in the information processing system 100 of this embodiment will be described with reference to FIGS. 10 to 13.

FIG. 10 is the first diagram showing an example display of a terminal device. Screen 101 shown in FIG. 10 is an example of a home screen displayed on terminal device 300 in step S603 of FIG. 6.

Screen 101 includes operation components 101a and 101b. Operation component 101a is an operation component for selecting task visualization information as the format of task content information. Operation component 101b is an operation component for selecting text data as the format of task content information. In information processing system 100 of this embodiment, when operation component 101a is selected on screen 101, the process proceeds to step S605 in FIG. 6, and when operation component 101b is selected, the process proceeds to step S613 in FIG. 6.

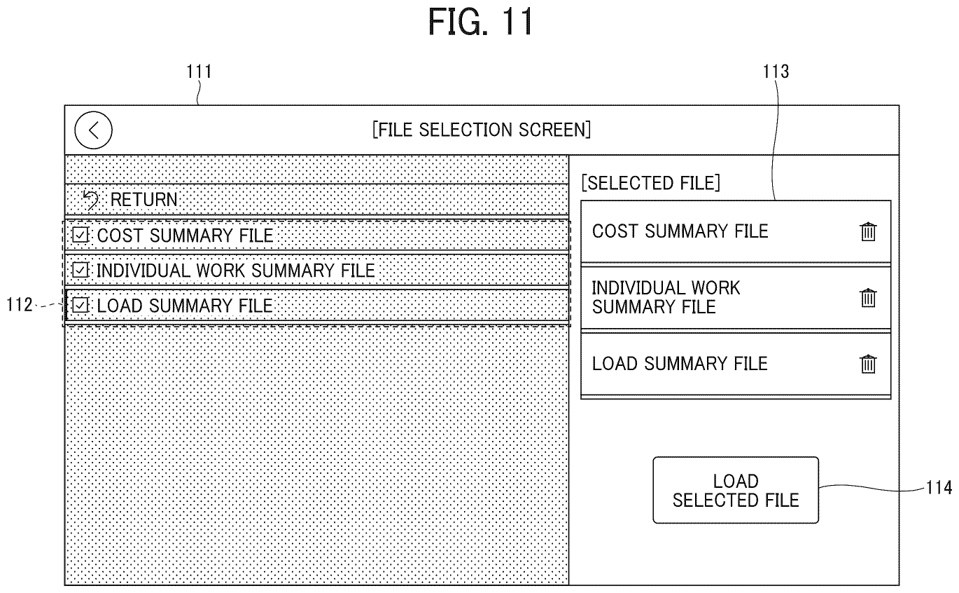

FIG. 11 is a second diagram showing an example display of a terminal device. Screen 111 shown in FIG. 11 is an example of a file selection screen displayed on terminal device 300 in step S607 of FIG. 6.

The screen 111 includes display areas 112 and 113, and an operation component 114. A list of task visualization information stored in the terminal device 300 is displayed in the display area 112. In addition, in the list of task visualization information displayed in the display area 112, a selection field for selecting task visualization information to be transmitted to the information processing device 200 is displayed in association with the task visualization information.

The display area 113 displays the task visualization information selected in the display area 112. The operation component 114 is an operation component for transmitting the task visualization information displayed in the display area 113 to the information processing device 200.

In the example of FIG. 11, “Cost summary file,” “Individual work summary file,” and “Load summary file” are selected as task visualization information in display area 112, and the three selected file names are displayed in display area 113.

The task visualization information corresponding to the “load summary file” may be task visualization information 70 shown in FIG. 7. The task visualization information corresponding to the “cost summary file” may be, for example, information that aggregates the cost for each process included in the development work of the A system. The task visualization information corresponding to the “individual work summary file” may be, for example, information that aggregates the load for each person in charge of a process included in the development work of the A system. The load may be working time, and the information that aggregates the load for each person in charge of a process included in the development work of the A system may be the cumulative working time for each person in charge of a process.

In the information processing system 100 of this embodiment, when the operating component 114 is operated on the screen 111, three types of task visualization information with file names displayed in the display area 113 are transmitted to the information processing device 200. Upon receiving the three types of task visualization information, the information processing device 200 causes the first analysis unit 250 to execute processing on each of the three types of task visualization information and causes the output unit 242 to display information indicating the analysis results on the terminal device 300.

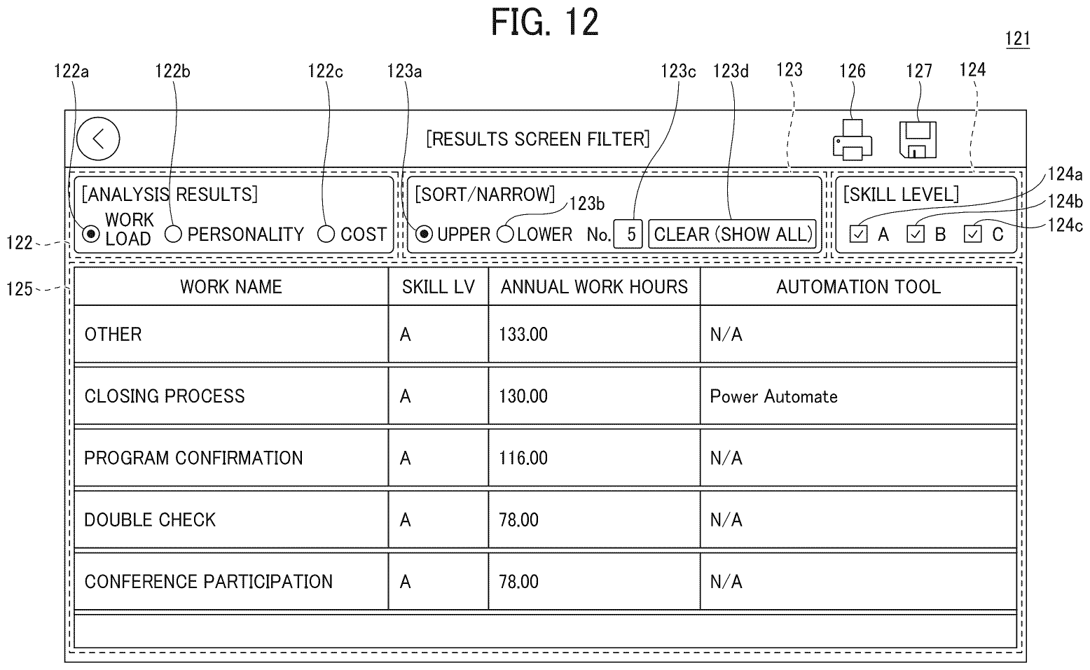

FIG. 12 is a third diagram showing an example display of a terminal device. Screen 121 shown in FIG. 12 is an example of an analysis result screen displayed on terminal device 300 in step S612 of FIG. 6.

A screen 121 shown in FIG. 12 includes display areas 122, 123, 124, and 125, and operation components 126 and 127.

Operation component 126 is an operation member for causing an image forming device or the like to print information indicating the analysis results displayed on screen 121.

Operation component 127 is an operation member for saving information indicating the analysis results displayed on screen 121 in a storage device or the like of information processing device 200.

Display area 122 includes operation members 122a, 122b, and 122c. These operation components are for selecting the type of task visualization information, and when multiple types of task visualization information are input, the analysis results of the type of task visualization information corresponding to the selection of the operation component are displayed in display area 123.

The operation component 122a is an operation component for displaying the analysis results of the task visualization information in which the processes included in the task are visualized by load. More specifically, in the example of FIG. 12, when the operation component 122a is selected, the analysis results obtained by processing the “load summary file” by the first analysis unit 250 are displayed in the display area 123.

The operation component 122b is an operation component for displaying the analysis results of the task visualization information in which the processes included in the task are visualized for each person in charge. More specifically, in the example of FIG. 12, when the operation component 122b is selected, the analysis results obtained by processing the “individual work summary file” by the first analysis unit 250 are displayed in the display area 123.

The operation component 122c is an operation component for displaying the analysis results of task visualization information in which the processes included in a task are visualized by cost. More specifically, in the example of FIG. 12, when the operation component 122c is selected, the analysis results obtained by processing the “cost summary file” by the first analysis unit 250 are displayed in the display area 123.

On the screen 121 shown in FIG. 12, the operation component 122a is selected, and the display area 123 displays information indicating the analysis results of the “load summary file.”

In this embodiment, by providing an operating member on screen 121 for selecting the type of task visualization information for which the analysis results are to be displayed, it is possible to display the analysis results of any of the task visualization information that has been input.

Display area 123 includes operation components 123a, 123b, 123c, and 123d.

Operation components 123a, 123b, and 123c are operation components for setting the display order of task processes to be displayed in display area 125, and operation component 123d is an operation component for canceling a setting made by any of operation components 123a, 123b, and 123c.

Operation component 123a is an operation component for displaying the task processes included in the task visualization information selected in display area 122 in order from the top of the tabulation results. Operation component 123b is an operation component for displaying the task processes included in the task visualization information selected in display area 122 in order from the bottom of the tabulation results. Operation component 123c is an operation component for displaying the task processes included in the task visualization information selected in display area 122 in order from the top of the tabulation results down to a specified rank.

In FIG. 12, operation component 122a is selected in display area 122, and operation component 123a is selected in display area 123. In this case, in display area 125, the analysis results are displayed in descending order of the task processes with the greatest load in the task visualization information that aggregates the load for each process included in the task.

Additionally, operation component 122a is selected, and operation component 123b is selected in display area 123. In this case, in display area 125, the analysis results are displayed in order of the task processes with the least load in the task visualization information that aggregates the load for each process included in the task.

In this embodiment, by focusing on processes with low load in this way, it is possible to propose automating tasks that have previously had a low load. By automating a low-load task, the personnel involved in that task can be reallocated to other tasks, increasing the likelihood that high-load tasks will be improved.

When operation component 122b is selected in display area 122 and operation component 123a is selected in display area 123, the analysis results are displayed in display area 125 in order of the task processes handled by the person with the heaviest load in the task visualization information that aggregates the load for each person in charge of the processes included in the task.

In addition, when operation component 122c is selected in display area 122 and operation component 123a is selected in display area 123, the analysis results are displayed in display area 125 in order of the task processes with the highest costs in the task visualization information that aggregates the costs of each process included in the task.

In this embodiment, the display order of task processes in display area 125 can be set according to the type of task visualization information selected in display area 122, allowing viewers of screen 121 to consider the automation of task processes from various perspectives.

The display area 124 includes operation components 124a, 124b, and 124c, which are used to select the skill level of the task process to be displayed in the display area 125.

The operation component 124a is an operation component for selecting a task process whose skill level is set to “A” in the task visualization information. The operation component 124b is an operation component for selecting a task process whose skill level is set to “B” in the task visualization information. The operation component 124c is an operation component for selecting a task process whose skill level is set to “C” in the task visualization information.

In this embodiment, when a skill level is selected in the display area 124, the analysis results including the task process corresponding to the selected skill level may be displayed in the display area 125.

In the example of FIG. 12, display area 124 includes operation components 124a, 124b, and 124c. An operation has been performed to select all of operation components 124a, 124b, and 124c. Therefore, display area 125 displays the analysis results including task processes corresponding to skill levels “A”, “B”, and “C”.

The display area 125 displays the analysis results by the first analysis unit 250. In the example of FIG. 12, the display area 125 displays, in association with each other, the names of task processes and the names of candidate tools that can automate the task processes. In other words, the display area 125 displays, in association with each other, task tasks that have been identified as tasks that can be supported by tools and candidate tools to be used to support the task tasks.

In addition, the display area 125 displays the name of the task process, the names of candidate tools for automating the task process, and the accumulated work time of the task process.

In addition, in display area 125, when task visualization information in which costs are aggregated for each process included in a task is selected in display area 122, the cost of the task process may be displayed instead of the cumulative working time of the task process.

Additionally, in the example of FIG. 12, task processes for which no candidate tools for automating the task process have been extracted are also displayed. Specifically, in the display area 125, task processes for which “N/A” is displayed next to the tool name corresponding to “Automation Tool” are processes that have not been identified as targets for automation.

In this embodiment, the names of task processes that are not specified as targets for automation may also be displayed in the display area 125 as part of the analysis results by the first analysis unit 250.

In this embodiment, by including task processes that were not identified as targets for automation as part of the analysis results, the viewer of screen 121 can understand whether there are any tools that could potentially realize automation.

In this embodiment, the display area 125 may be set to display only the task processes that are specified as targets for automation.

In addition, in this embodiment, task processes that are not identified as targets for automation may not be displayed in display area 125, and the tool names in display area 125 may be displayed as blanks rather than as “N/A.”

Furthermore, in this embodiment, information indicating the analysis results for displaying screen 121 may be stored in the information processing device 200. More specifically, in this embodiment, information indicating the analysis results by the first analysis unit 250 for the “load summary file”, “individual work summary file”, and “cost summary file” may be stored in the information processing device 200.

By doing this, for example, when an operation is performed to return from screen 121 to screen 111 and operation component 114 is selected again on screen 111, information processing device 200 can use information indicating the stored analysis results and can omit processing by first analysis unit 250. Therefore, in this embodiment, screen 111 displayed on terminal device 300 can be quickly transitioned to screen 121.

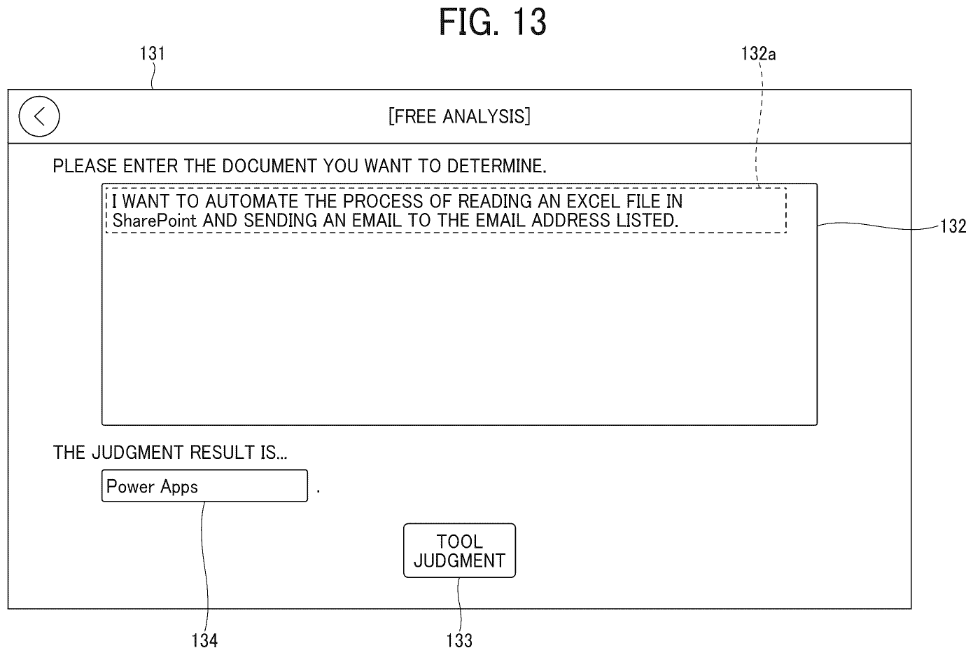

FIG. 13 is a fourth diagram showing an example of a display on the terminal device 300. A screen 131 shown in FIG. 13 is an example of an analysis result screen displayed on the terminal device 300 in step S620 of FIG. 6.

FIG. 13 includes an input area 132, an operation component 133, and a display area 134. The input area 132 is an input field for inputting text data indicating the content of the task. The operation component 133 is an operation component for transmitting the text data in the input area 132 to the information processing device 200 and causing the second analysis unit 260 to execute processing.

In this embodiment, when text data is input into the input area 132 on the screen 131 and then the operating component 133 is operated, the text data input into the input area 132 is transmitted to the information processing device 200, and processing is performed by the second analysis unit 260.

The display area 134 displays the analysis results by the second analysis unit 260. In other words, the display area 134 displays candidate tools for automating the content of the task indicated by the text data entered in the input area 132.

In the example of FIG. 13, the name of one tool may be displayed as a candidate tool in the display area 134, or the names of multiple tools may be displayed as candidates in the display area 134, or information indicating a combination of multiple tools may be displayed as candidates.

In this way, in this embodiment, even if the task content has not been visualized, by simply inputting any text data, it is possible to present candidate tools for automating the task content indicated by the text data.

Note that, in the example of FIG. 13, one sentence is input into input area 132, and one tool name is displayed in display area 134, but this is not limited to the above. Multiple tasks may be input as multiple sentences into input area 132, and in that case, the display area 134 may display the corresponding tool name for each of the multiple sentences.

In the above-described embodiment, task visualization information or text data is input as task content information, but this is not limited to this. In this embodiment, for example, information input to an application installed in the terminal device 300 may be acquired as task content information.

The applications installed on the terminal device 300 may include, for example, an application that provides a calendar function for managing personal schedules, an application for sending and receiving e-mail, an application that realizes a chat function, an application for realizing remote conferencing via the Internet, and the like.

In this embodiment, for example, the name of the meeting input to such an application may be treated as the task content information.

In addition, in this embodiment, the tool candidates displayed in the display area 125 of the screen 121 and the display area 134 of the screen 131 are displayed as tool candidates for automating the task process but are not limited to this. In this embodiment, the tool candidates displayed in the display area 125 of the screen 121 and the display area 134 of the screen 131 may be information indicating tools identified from the results of searching the tool information storage unit 230 based on the task content information. In other words, in this embodiment, when task content information indicating the content of a task that has already been automated is input, the terminal device 300 may similarly display tool candidates identified from the results of searching the tool information storage unit 230 based on the task content information for the task that has already been automated.

In this way, for example, it is possible to present to a user of the information processing system 100 potential tools that have the potential to further improve an already automated task.

Additionally, the devices described in each embodiment are merely representative of one of several computing environments for implementing the embodiments disclosed herein. In one embodiment, information processing apparatus 200 includes multiple computing devices, such as a server cluster. The multiple computing devices are configured to communicate with each other via any type of communication link, including a network, shared memory, etc., and perform the processing disclosed herein. Similarly, information processing apparatus 200 may include multiple computing devices configured to communicate with each other.

Furthermore, information processing device 200 can be configured to share the disclosed processing steps in various combinations. For example, a process performed by a specified unit can be executed by information processing device 200. Similarly, a function of a specified unit can be executed by information processing device 200. Also, in information processing device 200, each element may be consolidated into a single server or may be separated into multiple devices.

The information processing device 200 may be any device equipped with a communication function. The information processing device 200 may be, for example, a PJ (Projector), an output device such as digital signage, a HUD (Head Up Display) device, industrial machinery, an imaging device, a sound collection device, medical equipment, a network home appliance, an automobile (Connected Car), a notebook PC (Personal Computer), a mobile phone, a terminal device, a tablet terminal, a game console, a PDA (Personal Digital Assistant), a digital camera, a wearable PC, or a desktop PC.

What is claimed is:

1. An information processing apparatus comprising:
circuitry configured to:
receive input of task content information indicating content of a task;
determine whether the task is a task that can be supported by a tool based on the task content information; and
output information, to a terminal device, associating the task that can be supported by a tool with candidate tools to be used to support the task.

2. The information processing apparatus of claim 1, wherein the candidate tools to be used to support the task are extracted from a memory, in which tool information related to tools supporting the task are stored, based on the task content information.

3. The information processing apparatus of claim 2, wherein
the task content information is task visualization information that visualizes the task and includes processes included in the task,
at least one of the candidate tools used to support the task is existing software that automates at least one of the processes, and
the circuitry is further configured to control to display a screen on the terminal device that associates the at least one of the processes with the at least one of the candidate tools that automates the at least one of the processes, which is extracted from the memory based on the at least one of the processes.

4. The information processing apparatus of claim 3, wherein
the screen includes an operation component for setting a display order of the processes to be displayed on the screen; and
the processes are associated with the candidate tools in an order according to an operation of the operation component and are displayed on the screen.

5. The information processing apparatus of claim 3, wherein
the task visualization information includes at least one of information in which a load is aggregated for each of the processes, information in which a load is aggregated for each person in charge of the processes, or information in which a cost is aggregated for each of the processes;
the screen includes an operation component for selecting a type of the task visualization information; and
depending on the selected type of the task visualization information, at least one of the load for each of the processes, the load for each person in charge of the processes, or the cost for each of the processes is displayed on the screen.

6. The information processing apparatus of claim 3, wherein
the tool information is information in which a name of the at least one candidate tool that automates the at least one of the processes is associated with a keyword; and
the circuitry is further configured to:
search the memory for a name of the at least one of the processes;
determine the at least one of the processes from which the keyword is extracted as a search result as a task process to be automated;
extract a tool associated with the keyword as a result of the search in the tool information as the at least one of the candidate tools that automates the at least one of the processes; and
control to display on the terminal device a name of the task process to be automated and the at least one of the candidate tools that automates the at least one of the processes in association with each other.

7. The information processing apparatus of claim 1, wherein
the task content information is text data indicating a process of the task,
at least one of the candidate tools used to support the task is existing software that automates the process of the task, and
the circuitry is further configured to control to display on the terminal device a screen in which the text data is associated with a name of the at least one of the candidate tools that automates the process of the task indicated by the text data.

8. The information processing apparatus of claim 7, wherein the circuitry is further configured to:
extract words by analyzing the text data;
search a memory that stores tool information related to tools that support the task for each extracted word; and
extract tools associated with keywords as search results as candidates for tools that automate the process of the task indicated by the text data.

9. The information processing apparatus of claim 8, wherein the circuitry is further configured to extract a tool having the most keywords in a word-by-word search as the at least one of the candidate tools that automates the process of the task indicated by the text data.

10. The information processing apparatus of claim 1, wherein
the task content information includes content of a plurality of tasks, and
the circuitry is further configured to output, to the terminal device, information associating a candidate tool to be used to support a respective task for each of the plurality of tasks.

11. The information processing apparatus of claim 1, the circuitry is further configured to, in a case that the task is not determined as the task that can be supported by a tool, not output candidates for tools to be used to support the task to the terminal device.

12. An information processing system comprising;
an information processing apparatus; and
a terminal device, wherein
the information processing apparatus comprises circuitry configured to:
receive input of task content information indicating content of a task;
determine whether the task is a task that can be supported by a tool based on the task content information; and
output information, to a terminal device, associating the task that can be supported by a tool with candidate tools to be used to support the task, and
the terminal device comprises circuitry configured to display the information associating the task that can be supported by a tool with the candidate tools to be used to support the task.

13. An information processing method performed by an information processing apparatus, the method comprising;
receiving input of task content information indicating content of a task;
determining whether the task is a task that can be supported by a tool based on the task content information; and
outputting information, to a terminal device, associating the task that can be supported by a tool with candidate tools to be used to support the task.
